(19) United States
(12) Patent Application Publication
(10) Pub. No.: US 2022/0330134 A1
(43) Pub. Date: Oct. 13, 2022

(54) COMMUNICATION DEVICE, COMMUNICATION METHOD, AND COMMUNICATION SYSTEM

(71) Applicant: Panasonic Intellectual Property Management Co., Ltd., Osaka (JP)

(72) Inventors: Akira YAMASAKI, Osaka (JP); Nobuhiko ARASHIN, Osaka (JP); Sotaro SHINKAI, Osaka (JP); Hideyuki YAMADA, Hyogo (JP); Kazuki HASHIMOTO, Osaka (JP); Hiroshi OHUE, Osaka (JP); Yoshihiko ISHIDA, Kanagawa (JP); Senri SAKAI, Tokyo (JP)

(21) Appl. No.: 17/849,164

(22) Filed: Jun. 24, 2022

Related U.S. Application Data
(63) Continuation of application No. PCT/JP2020/045553, filed on Dec. 7, 2020.

(30) Foreign Application Priority Data
Dec. 27, 2019 (JP) 2019-239223
Nov. 4, 2020 (JP) PCT/JP2020/041255

(51) Int. Cl. H04W 48/04; H04W 72/08; H04W 28/02; H04W 76/18

(52) U.S. Cl. CPC H04W 48/04; H04W 72/08; H04W 28/0226; H04W 76/18

(57) ABSTRACT

A communication device includes: a distance information acquisition unit configured to acquire distance information indicating a distance to a communication target; a setting information acquisition unit configured to acquire setting information including a communication distance; and a communication unit configured to communicate with the communication target. The distance information acquisition unit acquires the distance information after the communication unit establishes connection with the communication target. The communication unit cuts the connection with the communication target when the distance information does not satisfy the communication distance included in the setting information.

### CROSS-REFERENCE TO RELATED APPLICATIONS

This is a continuation of International Application No. PCT/JP2020/045553 filed on Dec. 7, 2020, and claims priority from Japanese Patent Application No. 2019-239223 filed on Dec. 27, 2019 and International Application No. PCT/JP2020/041255 filed on Nov. 4, 2020, the entire content of which is incorporated herein by reference.

### TECHNICAL FIELD

The present disclosure relates to a communication device, a communication method, and a communication system.

### BACKGROUND ART

JP-A-2016-158103 discloses a wireless communication system forming a wireless network with a second wireless communication area within a first wireless communication area. The first wireless communication area is provided for communication by a first wireless communication scheme such as a wireless local area network (LAN), and the second wireless communication area is smaller than the first wireless communication area and provided for a second wireless communication scheme such as Bluetooth (registered trademark). In this wireless communication system, a predetermined area is formed within both of the first wireless communication area and the second wireless communication area. A device can perform communication using both of the wireless LAN and Bluetooth (registered trademark), and upon entering the predetermined area, the device acquires setup information such as authentication information and setting information set in the wireless LAN, and connects to the wireless LAN using the setup information. Upon exiting from Bluetooth (registered trademark), the device disconnects the communication by the wireless LAN. That is, the device can perform the communication by the wireless LAN using the setup information in a limited wireless communication area within the first wireless communication area of the wireless LAN where the limited wireless communication area overlaps with the second wireless communication area of Bluetooth (registered trademark).

### SUMMARY OF INVENTION

The present disclosure has been made in view of the above-described circumstances in the related art, and an object thereof is to provide a communication device, a communication method, and a communication system capable of performing wireless communication with a receiver located in a connection permitted area set by a user operation and also preventing wireless connection with a receiver located in a connection prohibited area set by a user operation.

The present disclosure provides a communication device including: a distance information acquisition unit configured to acquire distance information indicating a distance to a communication target; a setting information acquisition unit configured to acquire setting information including a communication distance; and a communication unit configured to communicate with the communication target. The distance information acquisition unit acquires the distance information after the communication unit establishes connection with the communication target, and the communication unit cuts the connection with the communication target in a case in which the distance information does not satisfy the communication distance included in the setting information.

The present disclosure provides a communication method including: acquiring distance information indicating a distance to a communication target after connection is established with the communication target; acquiring setting information including a communication distance; cutting the connection with the communication target in a case in which the distance information does not satisfy the communication distance included in the setting information; and communicating with the communication target when the distance information satisfies the communication distance included in the setting information.

The present disclosure provides a communication system including: a communication device capable of communicating with a communication target; and a setting terminal connected to the communication device to allow communication therebetween. The communication device includes: a distance information acquisition unit configured to acquire distance information indicating a distance to a communication target; a setting information acquisition unit configured to acquire, from the setting terminal, setting information including a communication distance and set by the setting terminal; and a communication unit configured to communicate with the communication target. The distance information acquisition unit acquires the distance information after the communication unit establishes connection with the communication target. The communication unit cuts the connection with the communication target in a case in which the distance information does not satisfy the communication distance included in the setting information.

According to the present disclosure, it is possible to perform wireless communication with a receiver located in a connection permitted area set by a user operation and also to prevent wireless connection with a receiver located in a connection prohibited area set by a user operation.

### BRIEF DESCRIPTION OF DRAWINGS

FIG. 1 is a diagram showing a system configuration example of a wireless communication system according to a first embodiment.

FIG. 2 is a block diagram showing a hardware configuration example of each of a millimeter wave transmitter and a setting computer.

FIG. 3 is a diagram showing an example of a communication area setting screen displayed on the setting computer.

FIG. 4 is a flowchart showing an example of an operation procedure of the millimeter wave transmitter according to the first embodiment.

FIG. 5 is a diagram showing another example of the communication area setting screen displayed on the setting computer.

FIG. 6 is a diagram showing an example of a communication area setting screen for two millimeter wave transmitters in which connection permitted areas may partially overlap.

FIG. 7 is a diagram showing another example of the communication area setting screen displayed on the setting computer.

FIG. 8 is a diagram showing another example of the communication area setting screen displayed on the setting computer.

FIG. 9 is a diagram showing a switching example of the communication area setting screen displayed on the setting computer.

### DESCRIPTION OF EMBODIMENTS

### Introduction to Present Disclosure

In JP-A-2016-158103, wireless communication using a wireless LAN such as Wi-fi (registered trademark) is implemented. Consequently, a transmitter can originally communicate with a receiver disposed within a uniform distance from a base station in almost all azimuths. However, even when an installation operator of a transmitter such as an access point designs a communication area and installs an access point in consideration of the use of the wireless LAN, there is an adverse effect, for example, an unintended receiver is connected due to a change in a radio propagation path or the like based on a change in a surrounding radio environment, or a receiver originally desired to be connected cannot be connected. Therefore, communication performance expected by the installation operator cannot be provided to a user (in other words, the receiver).

As a high-speed wireless communication scheme of data having a large data size, a wireless communication technique using a frequency in a millimeter wave band (for example, a 60 GHz band) is known. Radio waves in the millimeter wave band have a property of high straightness, and a wireless communication area can be flexibly expanded by using a beam forming technique. As described above, it will be expected to provide comfortable communication performance to the user by using wireless communication in a high frequency band such as a millimeter wave band, but JP-A-2016-158103 does not take such a consideration.

In the following first embodiment, an example of a communication system capable of providing comfortable wireless communication with a receiver located in a connection permitted area set by a user operation and prevents wireless connection with a receiver located in a connection prohibited area set by a user operation will be described.

Hereinafter, embodiments specifically disclosing a communication device, a communication method, and a communication system according to the present disclosure will be described in detail with reference to the drawings as appropriate. Unnecessarily detailed description may be omitted. For example, detailed description of a well-known matter or repeated description of substantially the same configuration may be omitted. This is to avoid unnecessary redundancy in the following description and to facilitate understanding of those skilled in the art. It should be noted that the accompanying drawings and the following description are provided for a thorough understanding of the present disclosure by those skilled in the art, and are not intended to limit the subject matter recited in the claims.

### First Embodiment

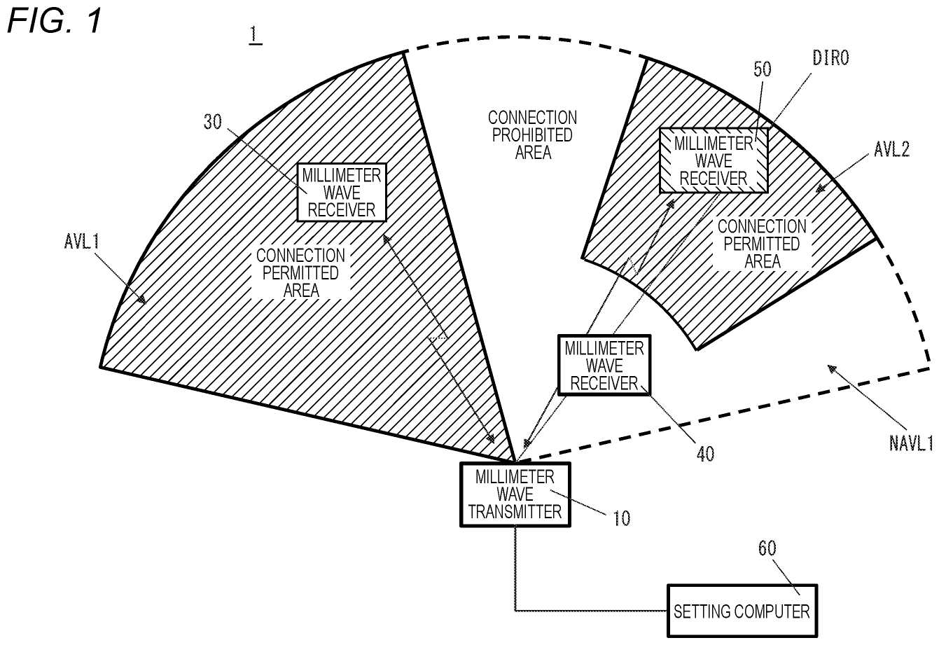

FIG. 1 is a block diagram showing a system configuration example of a wireless communication system 1 according to the first embodiment. The wireless communication system 1 as an example of the communication system includes a millimeter wave transmitter 10, one or more millimeter wave receivers 30, 40, and 50, and a setting computer 60. The millimeter wave receivers 30 to 50 may not be included in a configuration of the wireless communication system 1. The wireless communication system 1 is provided, for example, by a system installation operator or the like for offices, stores, shopping malls with a plurality of stores, or public facilities such as libraries.

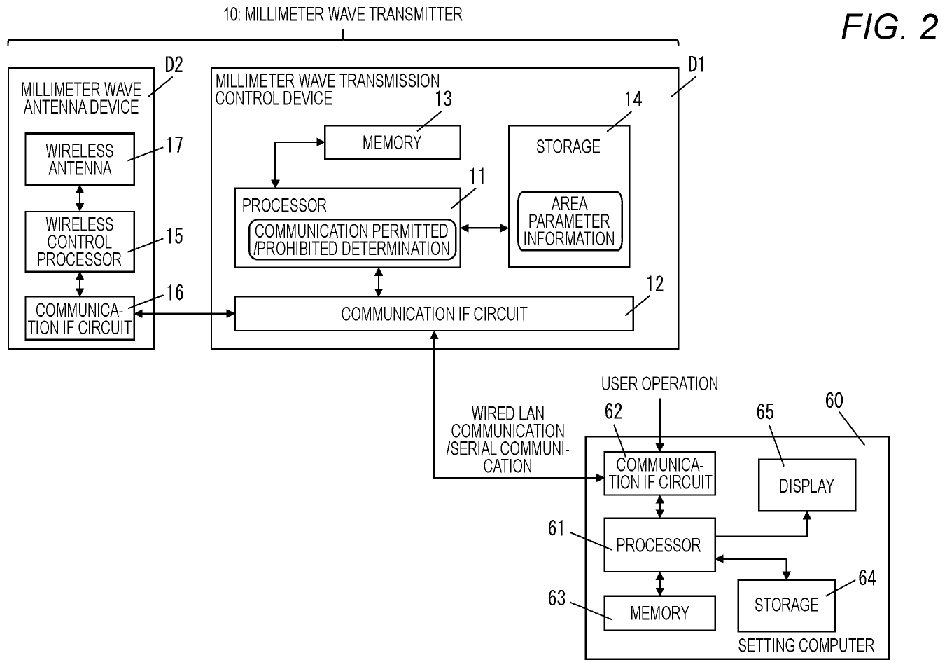

The millimeter wave transmitter 10 as an example of the communication device can perform data communication with the millimeter wave receivers 30 to 50 using a wireless resource in a high frequency band of, for example, a 60 GHz band. The millimeter wave transmitter 10 is connected to the setting computer 60 in a wired manner (for example, a wired LAN or serial communication) or a wireless manner (for example, a wireless LAN or Bluetooth (registered trademark)) so as to enable data communication. Wired communication may include communication via a universal serial bus (USB) cable. In the following description, it is assumed that the millimeter wave transmitter 10 and the setting computer 60 are connected in a wired manner, such as using a LAN cable. A detailed hardware configuration example of each of the millimeter wave transmitter 10 and the setting computer 60 will be described later with reference to FIG. 2.

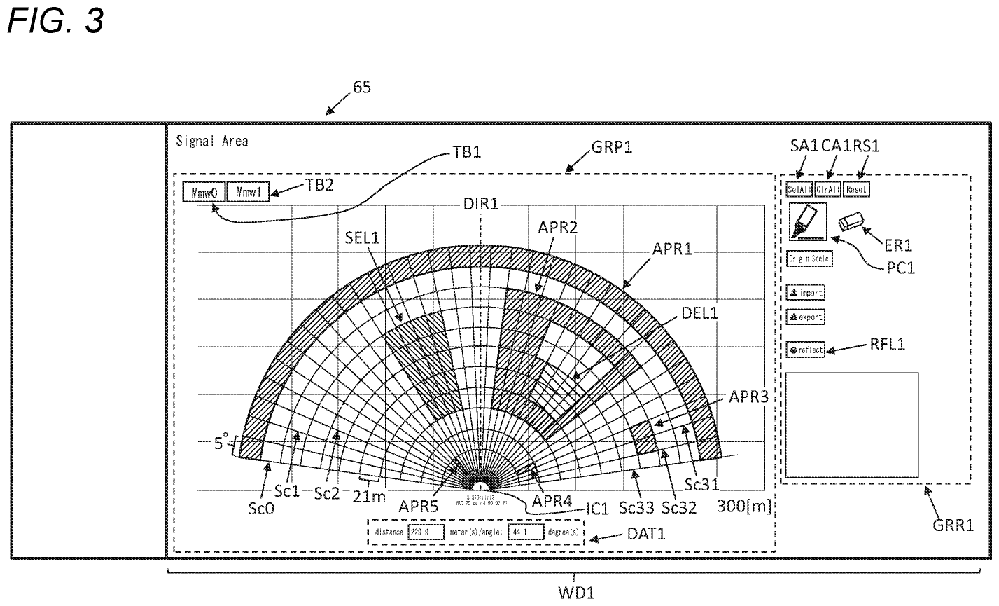

The millimeter wave transmitter 10 performs millimeter wave communication with stations (for example, the millimeter wave receivers 30 and 50) located in connection permitted areas AVL1 and AVL2 respectively in accordance with area parameter information generated by a setting operation (see FIG. 3) using the setting computer 60 by an administrator of the wireless communication system 1 (for example, a system operator or a system administrator, the same applies hereinafter).

Here, the area parameter information includes, for example, information indicating a range of a connection permitted area and a connection prohibited area, which is determined according to a distance and an azimuth (a direction, see a sector ID to be described later) with a position of the millimeter wave transmitter 10 as an origin, information indicating a maximum communication distance from the millimeter wave transmitter 10, and information indicating a maximum communication direction (angle) from the millimeter wave transmitter 10. The area parameter information defines a connection permitted area and a connection prohibited area according to at least one of the information indicating (distance, azimuth), for example, (distance). The area parameter information is generated by the setting computer 60 and transmitted to the millimeter wave transmitter 10. The millimeter wave transmitter 10 can perform wireless communication according to an intention of a user by selecting a millimeter wave receiver to be subjected to the millimeter wave communication in accordance with the area parameter information.

On the other hand, the millimeter wave transmitter 10 does not perform the millimeter wave communication with a station (for example, the millimeter wave receiver 40) located in a connection prohibited area NAVL1 in accordance with the above-described area parameter information. Details of the setting operation related to the generation of the area parameter information will be described later with reference to FIG. 3.

Here, the connection permitted areas AVL1 and AVL2 indicate areas (ranges) in which permission for the millimeter wave transmitter 10 to perform the millimeter wave communication is set. The connection prohibited area NAVL1 indicates an area (a range) in which prohibition of use of the millimeter wave transmitter 10 for performing the millimeter wave communication is set. The connection permitted areas AVL1 and AVL2 and the connection prohibited area NAVL1 are defined in accordance with the above-described system operation policy of the user or a relationship with an arrangement position of an obstacle such as an electronic device (not shown) capable of emitting surrounding radio waves, and the area parameter information (see above) indicating the areas is generated by the setting computer 60 in accordance with a user operation.

As shown in FIG. 1, the millimeter wave receiver 30 is located in the connection permitted area AVL1. The millimeter wave transmitter 10 establishes wireless connection at least once in order to perform data communication with the millimeter wave receiver 30, and at this time, specifies a position of the millimeter wave receiver 30 based on a calculation result of a distance and an azimuth of the millimeter wave receiver 30 (see below). Therefore, the millimeter wave transmitter 10 determines that the calculation result of the distance and the azimuth of the millimeter wave receiver 30 satisfies the connection permitted area of the area parameter information, and performs the millimeter wave communication with the millimeter wave receiver 30.

As shown in FIG. 1, the millimeter wave receiver 40 is located in the connection prohibited area NAVL1. The millimeter wave transmitter 10 establishes wireless connection at least once in order to perform data communication with the millimeter wave receiver 40, and at this time, specifies a position of the millimeter wave receiver 40 based on a calculation result of a distance and an azimuth of the millimeter wave receiver 40 (see below). Therefore, the millimeter wave transmitter 10 determines that the calculation result of the distance and the azimuth of the millimeter wave receiver 40 satisfies the connection prohibited area of the area parameter information (does not satisfy the connection permitted area), and cannot perform the millimeter wave communication with the millimeter wave receiver 40.

As shown in FIG. 1, the millimeter wave receiver 50 is located in the connection permitted area AVL2. The millimeter wave transmitter 10 establishes wireless connection at least once in order to perform data communication with the millimeter wave receiver 50, and at this time, specifies a position of the millimeter wave receiver 50 based on a calculation result of a distance and an azimuth of the millimeter wave receiver 50 (see below). Therefore, the millimeter wave transmitter 10 determines that the calculation result of the distance and the azimuth of the millimeter wave receiver 50 satisfies the connection permitted area of the area parameter information, and performs the millimeter wave communication with the millimeter wave receiver 50.

Here, the connection permitted area AVL2 is located farther from the position of the millimeter wave transmitter 10 than the connection prohibited area NAVL1. However, for example, in millimeter wave communication (transmission and reception) in a 60 GHz band, data communication can be performed with a communication partner (that is, a millimeter wave receiver) at any distance and azimuth (that is, a sector ID indicating a direction) using beam forming. Accordingly, the millimeter wave transmitter 10 cannot perform the millimeter wave communication with the millimeter wave receiver 40 located on a front side (a near side) of an own device (that is, the millimeter wave transmitter 10), but can perform the millimeter wave communication with, for example, the millimeter wave receiver 50 which is present in the same direction DIR0 as the millimeter wave receiver 40 when viewed from the millimeter wave transmitter 10 but is located on a far side of the own device (that is, the millimeter wave transmitter 10).

FIG. 2 is a block diagram showing the hardware configuration example of each of the millimeter wave transmitter 10 and the setting computer 60. The millimeter wave transmitter 10 includes separate bodies which are a millimeter wave transmission control device D1 and a millimeter wave antenna device D2, but the millimeter wave transmission control device D1 and the millimeter wave antenna device D2 may be integrated. In the latter configuration, a communication IF circuit 12 and a communication IF circuit 16 may be integrated. In the following description, it is assumed that the millimeter wave transmission control device D1 and the millimeter wave antenna device D2 are connected in a wired manner, such as using a USB cable.

The millimeter wave transmission control device D1 includes a processor 11, the communication IF circuit 12, a memory 13, and a storage 14.

The processor 11 includes, for example, a central processing unit (CPU), a digital signal processor (DSP), or a field programmable gate array (FPGA). The processor 11 controls an operation of each unit of the millimeter wave transmission control device D1 (in other words, the millimeter wave transmitter 10). The processor 11 functions as a control unit of the millimeter wave transmission control device D1, and performs a control process for controlling overall operations of the units of the millimeter wave transmission control device D1, a data input/output process with the units of the millimeter wave transmission control device D1, a data computation (calculation) process, and a data storage process. The processor 11 operates in accordance with execution of a program stored in a ROM in the memory 13.

The processor 11 as an example of a setting information acquisition unit acquires the area parameter information stored in the storage 14 and stores the area parameter information in the storage 14. The processor 11 calculates and specifies, with reference to the area parameter information, a position (specifically, a distance and an azimuth from the millimeter wave transmitter 10) of an external wireless connection terminal (for example, the millimeter wave receivers 30 to 50) that performs a wireless connection process via the communication IF circuits 12 and 16.

The processor 11 as an example of a distance information acquisition unit calculates a distance to the external wireless connection terminal according to a round trip time (RTT). The processor 11 may calculate the distance to the external wireless connection terminal with a predetermined conversion formula using a received radio wave intensity such as a received signal strength indicator (RSSI).

The processor 11 as an example of a direction information acquisition unit scans and forms directivity for each azimuth by beam forming, and calculates an azimuth in which a received radio wave intensity of a wireless signal (a radio wave) transmitted from the external wireless connection terminal is the strongest as an azimuth of the external wireless connection terminal. An example of calculating a position of the external wireless connection terminal (in other words, the distance and the azimuth from the millimeter wave transmitter 10) is not limited to the above-described method.

For example, the processor 11 determines whether data communication using millimeter waves is permitted with the external wireless connection terminal based on a comparison between information indicating the calculated result (specifically, data indicating the distance and the azimuth) and the area parameter information.

The communication IF circuit 12 as an example of a communication unit performs wireless connection or data communication (transmission and reception) using millimeter waves with the external wireless connection terminal (for example, the millimeter wave receivers 30 to 50) via the millimeter wave antenna device D2. The communication IF circuit 12 performs data communication (transmission and reception) with the setting computer 60 via wired LAN communication or serial communication. In FIG. 2, an “interface” is abbreviated as “IF” for simplicity of illustration.

The memory 13 includes, for example, a random access memory (RAM) and a read only memory (ROM), and temporarily stores a program required to execute an operation of the millimeter wave transmission control device D1 (in other words, the millimeter wave transmitter 10), and data or information generated by the processor 11 during the operation. The RAM is, for example, a work memory used when the processor 11 operates. The ROM pre-stores, for example, a program and data for controlling the processor 11.

The storage 14 includes, for example, a hard disk drive (HDD), a flash memory, or a solid state drive (SSD), and stores data acquired or generated by the processor 11. For example, the storage 14 stores data of the area parameter information generated by the setting computer 60.

The millimeter wave antenna device D2 includes a wireless control processor 15, the communication IF circuit 16, and a wireless antenna 17.

The wireless control processor 15 includes, for example, a CPU, a DSP, or an FPGA. The wireless control processor 15 controls an operation of each unit of the millimeter wave antenna device D2 (in other words, the millimeter wave transmitter 10). The wireless control processor 15 functions as a control unit of the millimeter wave antenna device D2, and performs a control process for controlling overall operations of the units of the millimeter wave antenna device D2, a data input/output process with the units of the millimeter wave antenna device D2, a data computation (calculation) process, and a data storage process. The wireless control processor 15 operates in accordance with execution of a program stored in a ROM (not shown) built in the millimeter wave antenna device D2.

With reference to a distance and an azimuth that indicate a position of an external wireless connection terminal (for example, the millimeter wave receiver 30 located in the connection permitted area AVL1) calculated by the processor 11, the wireless control processor 15 forms directivity based on beam forming toward the position of the external wireless connection terminal (for example, the millimeter wave receiver 30) using the wireless antenna 17, and continuously performs wireless connection with the same external wireless connection terminal. Accordingly, the millimeter wave transmitter 10 can perform millimeter wave communication based on beam forming with, for example, the millimeter wave receiver 30 located in the connection permitted area AVL1.

With reference to a distance and an azimuth that indicate a position of an external wireless connection terminal (for example, the millimeter wave receiver 40 located in the connection prohibited area NAVL1) calculated by the processor 11, the wireless control processor 15 cuts wireless connection with the external wireless connection terminal (for example, the millimeter wave receiver 40). Accordingly, the millimeter wave transmitter 10 can stop performing millimeter wave communication with, for example, the millimeter wave receiver 40 located in the connection prohibited area NAVL1. When the millimeter wave receiver 40 is movable and moves from the connection prohibited area NAVL1 to the connection permitted area AVL2, the millimeter wave transmitter 10 can perform millimeter wave communication with the millimeter wave receiver 40 after performing wireless connection with the millimeter wave receiver 40 that moves into the connection permitted area AVL2.

The communication IF circuit 16 as an example of the communication unit performs wireless connection or data communication (transmission and reception) using millimeter waves with an external wireless connection terminal (for example, the millimeter wave receivers 30 to 50). The communication IF circuit 16 performs data communication (transmission and reception) with the communication IF circuit 12.

The wireless antenna 17 as an example of the communication unit forms directivity at a predetermined distance and azimuth under a control of the wireless control processor 15, transmits a wireless signal in a millimeter wave band generated by the wireless control processor 15, or receives a wireless signal transmitted from an external wireless connection terminal (for example, the millimeter wave receiver 30) being wirelessly connected.

The setting computer 60 as an example of a setting terminal includes a processor 61, a communication IF circuit 62, a memory 63, a storage 64, and a display 65. The setting computer 60 includes, for example, a personal computer capable of receiving an external input operation of a mouse or the like (not shown) by a user (see above).

The processor 61 includes, for example, a CPU, a DSP, or an FPGA. The processor 61 controls an operation of each unit of the setting computer 60. The processor 61 functions as a control unit of the setting computer 60, and performs a control process for controlling overall operations of the units of the setting computer 60, a data input/output process with the units of the setting computer 60, a data computation (calculation) process, and a data storage process. The processor 61 operates in accordance with execution of a program stored in a ROM in the memory 63.

For example, the processor 61 generates, by a user operation received by the communication IF circuit 62, area parameter information (an example of setting information) indicating a position (a range) of each of a connection permitted area and a connection prohibited area designated on a communication area setting screen (see FIG. 3, 7, 8, or 9), and transmits the area parameter information to the millimeter wave transmitter 10 via the communication IF circuit 62.

The communication IF circuit 62 receives an operation signal transmitted from an input device (not shown) such as a mouse by a user operation and transmits the operation signal to the processor 61. The communication IF circuit 62 performs wired or wireless data communication (transmission and reception) with the millimeter wave transmitter 10. For example, the communication IF circuit 62 performs data communication (transmission and reception) with the millimeter wave transmitter 10 via wired LAN communication or serial communication.

The memory 63 includes, for example, a RAM and the ROM, and temporarily stores a program required to execute an operation of the setting computer 60 and data or information generated by the processor 61 during the operation. The RAM is, for example, a work memory used when the processor 61 operates. The ROM pre-stores, for example, a program and data for controlling the processor 61.

The storage 64 includes, for example, an HDD, a flash memory, or an SSD, and stores data acquired or generated by the processor 61. For example, the storage 64 stores data of the area parameter information generated by the processor 61.

The display 65 is a display device including, for example, a liquid crystal display (LCD) or an organic electroluminescence (EL). The display 65 displays, by a user operation, the communication area setting screen (see FIG. 3) transmitted from the processor 61.

FIG. 3 is a diagram showing an example of the communication area setting screen displayed on the setting computer 60. A communication area setting screen WD1 is displayed on the display 65 of the setting computer 60 by a user operation. In the communication area setting screen WD1, a position allowed as a position of a millimeter wave receiver to which the millimeter wave transmitter 10 performs millimeter wave communication is designated according to two parameters of a distance and an azimuth. Specifically, the communication area setting screen WD1 includes a display area of an area designation field GRP1 in which a position to be a communication area of the millimeter wave transmitter 10 is designated, and a display area of a designation tool field GRR1 which supports designation by a user operation. In FIG. 3, two types of area designation fields GRP1 are displayed, and one area designation field GRP1 corresponding to a tab specified by designation for tabs TB1 and TB2 is displayed. In FIG. 3, the area designation field GRP1 corresponding to the tab TB2 is displayed.

The area designation field GRP1 receives the above-described designation of the connection permitted area and the connection prohibited area by the user operation in a circular sector communication area with the position of the millimeter wave transmitter 10 indicated by an icon IC1 as a center (in other words, an origin of a two-dimensional coordinate system). Each of the connection permitted area and the connection prohibited area is designated in a form of two-dimensional coordinates of (distance, azimuth). For example, a position in an area SEL1 currently selected (designated) by a mouse or the like is indicated as (229.9 m, −44.1 degrees) specified by a current value data display field DAT1. The “distance” indicates a distance at which the millimeter wave transmitter 10 can perform millimeter wave communication, and a distance that can be set in the area designation field GRP1 in FIG. 3 is set to, for example, about 264 m at the maximum. Similarly, the “azimuth” indicates a range (a direction) in which the millimeter wave transmitter 10 can form directivity by beam forming when viewed from its own position, and is set to about 165 degrees at the maximum in the example in FIG. 3.

In the circular sector communication area, when viewed from the position of the icon IC1 (that is, the center as the origin), the “distance” can be designated according to a length in a radial direction. For example, the length in the radial direction is divided into 12 cells, and one cell indicates 22 m (=264÷12). The length indicated by division of squares is not limited to 22 m, and can be appropriately set according to a transmission distance that can be used by the millimeter wave transmitter 10 or the number of squares.

In the circular sector communication area, the “azimuth” can be designated by a sector ID indicating an azimuth (a 5-degree interval) specified by two adjacent azimuth lines among a total of 34 azimuth lines Sc0, Sc1, Sc2, . . . , Sc31, Sc32, and Sc33. In the “azimuth”, a front direction DIR1 is 0 degrees when viewed from the millimeter wave transmitter 10 corresponding to the icon IC1. For example, when viewed from the icon IC1, a direction between the adjacent azimuth lines Sc0 and Sc1 is defined as a sector ID=0, a direction between the adjacent azimuth lines Sc1 and Sc2 is defined as a sector ID=1, and similarly, a direction between the adjacent azimuth lines Sc31 and Sc32 is defined as a sector ID=31, and a direction between the adjacent azimuth lines Sc32 and Sc33 is defined as a sector ID=32. Each sector ID is provided in increments of 5 degrees. That is, the sector ID is a parameter indicating the azimuth from the position of the millimeter wave transmitter 10.

For example, in FIG. 3, (distance, azimuth) indicating each of user designation areas APR1, APR2, APR3, APR4, and APR5 is designated by a user operation as a connection permitted area, so that the setting computer 60 generates area parameter information for setting the user designation area APR1 as the connection permitted area. In other words, the setting computer 60 generates area parameter information for setting an area other than the user designation areas APR1, APR2, APR3, APR4, and APR5 (that is, an area not designated by the user operation) as a connection prohibited area.

The designation tool field GRR1 displays icons of various tools for assisting the designation operation of the user in the area designation field GRP1. The icons of various tools include an all-selection icon SA1, an all-clear icon CAL a reset icon RS1, a drawing icon PC1, an eraser icon ER1, and a reflection icon RFL1.

The all-selection icon SA1 is designated by a user operation when all areas of the communication area in the area designation field GRP1 are collectively selected as connection permitted areas.

The all-clear icon CA1 is designated by a user operation when all currently selected areas of the communication area in the area designation field GRP1 are cleared.

The reset icon RS1 is designated by a user operation when a selection as a connection permitted area of one time is reset immediately before the communication area in the area designation field GRP1.

The drawing icon PC1 is designated by a user operation when any area is drawn and selected as a connection permitted area with respect to the communication area in the area designation field GRP1. An area (for example, the area SEL1) selected as a connection permitted area candidate but not determined as the connection permitted area may be displayed in a distinguishable manner, for example, in a color different from a color indicating a determined connection permitted area (for example, the user designation area APR1).

The eraser icon ER1 is designated when the connection permitted area candidate drawn and selected by the user operation in the communication area in the area designation field GRP1 is deleted by a user operation. An area candidate (for example, an area DEL1) to be deleted from the connection permitted area may be displayed in a distinguishable manner, for example, in a color different from a color indicating the determined connection permitted area (for example, the user designation area APR1) and the area (for example, the area SEL1) being selected as the connection permitted area candidate.

The reflection icon RFL1 is designated by a user operation when an instruction is made for setting and reflection of an area (for example, the area SEL1) currently selected as a connection permitted area candidate or an area candidate (for example, the area DEL1) to be deleted from the connection permitted area. That is, the area (for example, the area SEL1) selected as the currently connection permitted area candidate is set as the connection permitted area determined by the processor 61 only after the reflection icon RFL1 is pressed (designated) by the user operation, and (distance, azimuth) indicating a range of this area is registered in the area parameter information. Similarly, the area candidate (for example, the area DEL1) to be deleted from the connection permitted area is excluded from the connection permitted area by the processor 61 only after the reflection icon RFL1 is pressed (designated) by the user operation, and (distance, azimuth) indicating a range of this area is deleted from the area parameter information.

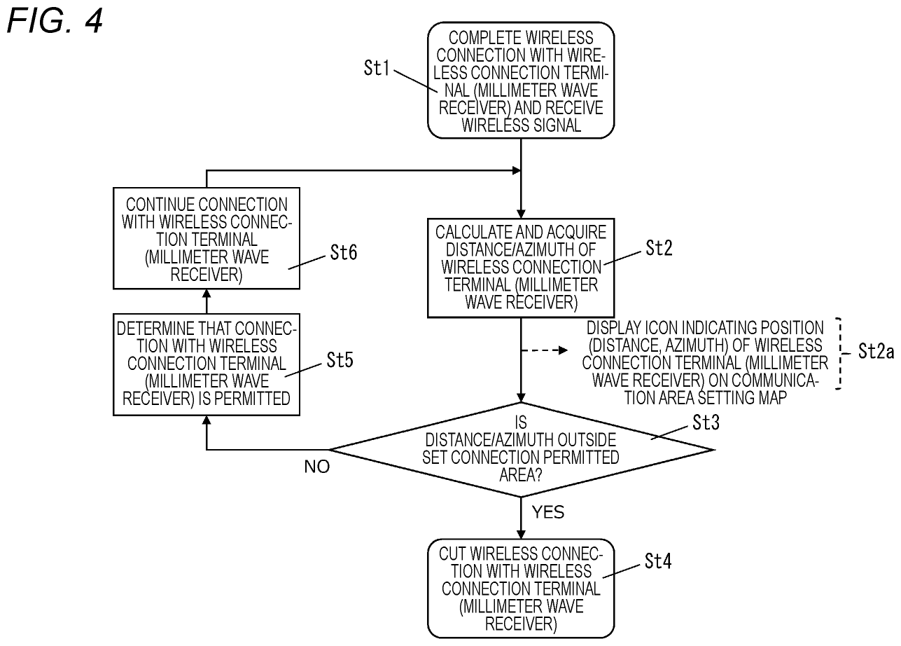

Next, an example of an operation procedure of the millimeter wave transmitter 10 of the wireless communication system 1 according to the first embodiment will be described with reference to FIG. 4. FIG. 4 is a flowchart showing the example of the operation procedure of the millimeter wave transmitter 10 according to the first embodiment. As a premise of description of FIG. 4, a position of a millimeter wave receiver (in other words, area parameter information of a connection permitted area) at which the millimeter wave transmitter 10 is permitted to perform millimeter wave communication is already generated by the setting computer 60 and received and set by the millimeter wave transmitter 10.

In FIG. 4, the millimeter wave transmitter 10 completes wireless connection with a wireless connection terminal (that is, the millimeter wave receiver), and receives a wireless signal transmitted from the wireless connection terminal (SU). The millimeter wave transmitter 10 calculates and specifies a position (specifically, a distance and an azimuth from the millimeter wave transmitter 10) of an external wireless connection terminal (for example, the millimeter wave receivers 30 to 50) (St2). For example, the millimeter wave transmitter 10 calculates a distance to the external wireless connection terminal according to a round trip time (RTT), scans directivity for each azimuth by beam forming, and calculates an azimuth in which a received radio wave intensity is the strongest as an azimuth of the wireless connection terminal.

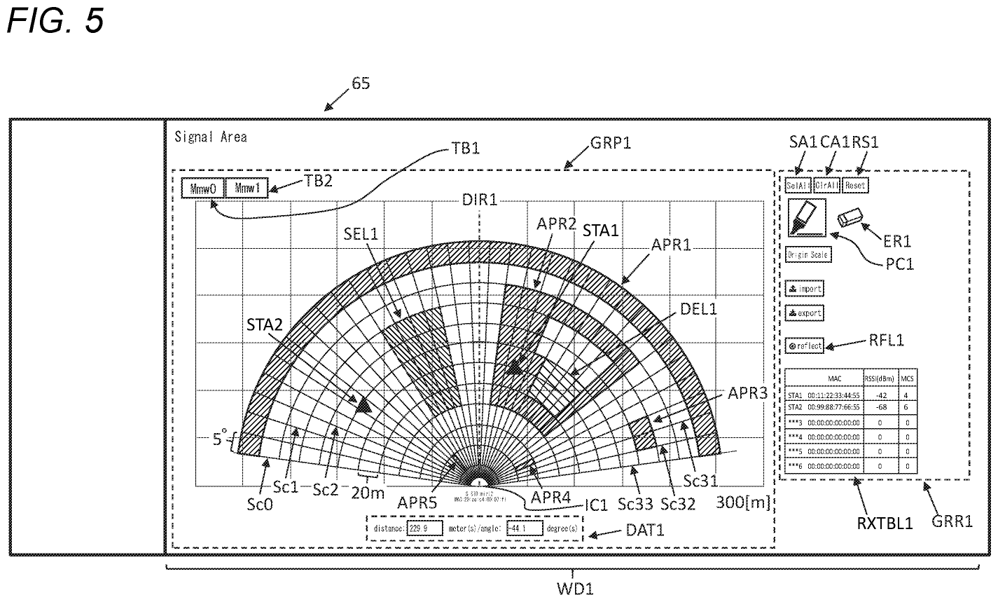

When the setting computer 60 is connected to the millimeter wave transmitter 10 in a wired manner or the like and a communication area setting screen WD1 is displayed on the setting computer 60 (see FIG. 5), the millimeter wave transmitter 10 may transmit, to the setting computer 60, a display instruction of an icon STA1 or an icon STA2 indicating the position of the wireless connection terminal calculated in step St2 (St2a). The setting computer 60 displays the position of the wireless connection terminal in a manner of being superimposed on a corresponding position of the circular sector communication area of the area designation field GRP1 of the communication area setting screen WD1 based on the display instruction from the millimeter wave transmitter 10. Accordingly, the user can easily and quickly grasp, by simply visually checking the communication area setting screen WD1, a position of a wireless connection terminal (that is, the millimeter wave receiver) that is just wirelessly connected. The process of step St2a may be omitted.

The millimeter wave transmitter 10 determines whether the (distance, azimuth) calculated in step St2 is included in the area parameter information generated by the setting computer 60 (in other words, whether the wireless connection terminal wirelessly connected in step St′ is in the connection permitted area) (St3). When it is determined that the wireless connection terminal is not in the connection permitted area (St3, YES), the millimeter wave transmitter 10 cuts the wireless connection with the wireless connection terminal (that is, the millimeter wave receiver) wirelessly connected in step St′ (St4). Accordingly, the millimeter wave transmitter 10 can avoid performing millimeter wave communication with a millimeter wave receiver (for example, the millimeter wave receiver 40) located in a connection prohibited area (for example, the connection prohibited area NAVL1) generated by the setting computer 60.

On the other hand, when it is determined that the wireless connection terminal is in the connection permitted area (St3, NO), the millimeter wave transmitter 10 determines to permit wireless connection for millimeter wave communication with a millimeter wave receiver (for example, the millimeter wave receiver 30) located in the connection permitted area (for example, the connection permitted area AVL1) (St5). The millimeter wave transmitter 10 performs or continuously performs millimeter wave communication with the millimeter wave receiver (for example, the millimeter wave receiver 30) located in the connection permitted area (for example, the connection permitted area AVL1) (St6). The process of the millimeter wave transmitter 10 after step St6 returns to step St1, and the processes from step St2 to step St6 are repeated until it is determined that the wireless connection terminal being wirelessly connected is not in the connection permitted area.

FIG. 5 is a diagram showing another example of the communication area setting screen displayed on the setting computer 60. In description of FIG. 5, the same elements as those in FIG. 3 are denoted by the same reference numerals, description thereof will be simplified or omitted, and different contents will be described.

The communication area setting screen WD1 in FIG. 5 is displayed on the display 65 of setting computer 60 by a user operation, similarly to the communication area setting screen WD1 in FIG. 3. In the communication area setting screen WD1 in FIG. 5, the setting computer 60 displays the icon STA1 or the icon STA2, which indicates the position of the wireless connection terminal being wirelessly connected to the millimeter wave transmitter 10 (see step St1), in a manner of being superimposed on the corresponding position of the circular sector communication area of the area designation field GRP1 of the communication area setting screen WD1 in accordance with the display instruction (see step St2a) from the millimeter wave transmitter 10. Further, the setting computer 60 displays, in the designation tool field GRR1, a communication environment information table RXTBL1 indicating communication environment information regarding the wireless connection terminal (that is, the millimeter wave receiver) being currently wirelessly connected.

The communication environment information table RXTBL1 stores a record indicating a group of a media access control (MAC) address, an RSSI, and a modulation and coding scheme (MCS) for each wireless connection terminal (that is, the millimeter wave receiver) being wirelessly connected to the millimeter wave transmitter 10.

For example, when the wireless connection terminal that is just wirelessly connected to the millimeter wave transmitter 10 is shown as the icon STA1, the setting computer 60 continuously displays the icon STA1 as long as the corresponding wireless connection terminal is being wirelessly connected because a position of the icon STA1 is within the user designation area APR2 (in other words, the connection permitted area). On the other hand, for example, when the wireless connection terminal that is just wirelessly connected to the millimeter wave transmitter 10 is shown as the icon STA2, the setting computer 60 hides the display of the icon STA2 after a certain display period (for example, 5 seconds) or a display update period (for example, 1 second) of the communication area setting screen WD1 elapses because a position of the icon STA2 is within an area that is not the user designation area, in other words, within a connection prohibited area.

For example, when the wireless connection terminal that is just wirelessly connected to the millimeter wave transmitter 10 is shown as the icon STA2, the setting computer 60 may continuously display the icon STA2 although the position of the icon STA2 is within the connection prohibited area. Accordingly, the user can grasp the number of wireless connection terminals (that is, millimeter wave receivers) that are being currently wirelessly connected in the connection prohibited area, and therefore, for example, when there are a certain number of wireless connection terminals, it is possible to dynamically perform a setting change for switching the connection prohibited area to the connection permitted area, thereby realizing comfortable millimeter wave communication.

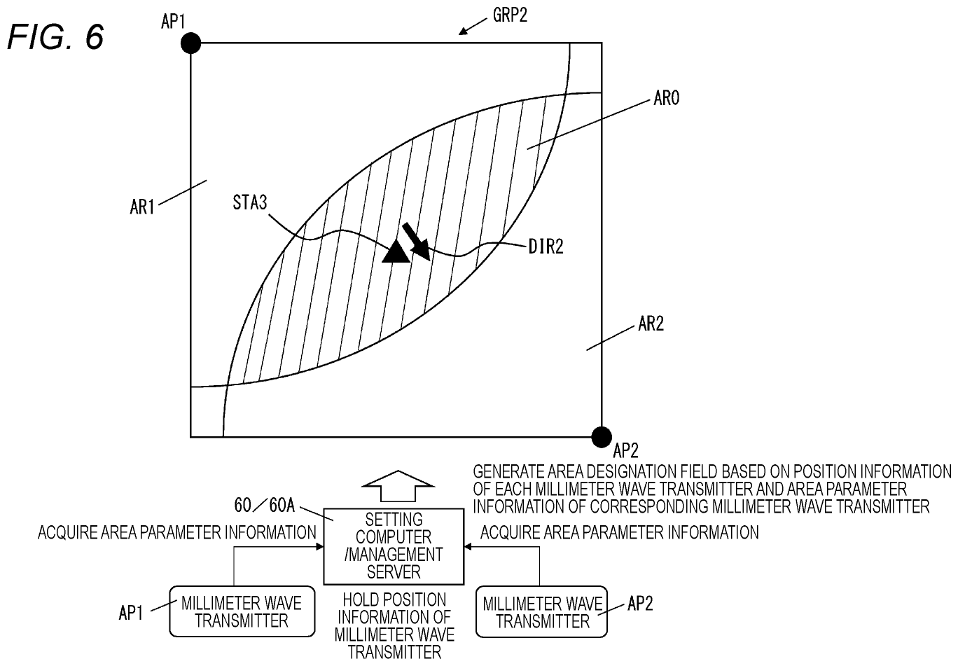

FIG. 6 is a diagram showing an example of a communication area setting screen for two millimeter wave transmitters in which connection permitted areas may partially overlap. In FIG. 6, an area designation field GRP2 in which a rectangular communication area is defined is extracted from the communication area setting screen WD1 in FIG. 3 or the communication area setting screen WD1 in FIG. 5. Icons respectively indicating two millimeter wave transmitters (for example, access points AP1 and AP2) having the same configuration as the millimeter wave transmitter 10 are disposed at a pair of opposing vertex portions of the rectangular communication area. Similarly, for the access points AP1 and AP2, it is possible to set two circular sector communication areas AR1 and AR2, respectively.

The setting computer 60 or a management server 60A having the same hardware configuration as the setting computer 60 can set the communication area of each of the plurality of access points AP1 and AP2 on one screen (that is, the area designation field GRP2) in response to an operation on the area designation field GRP2 in FIG. 6 by the user. As described above, the hardware configuration of the management server 60A is the same as the hardware configuration of the setting computer 60 (see FIG. 2), and thus illustration of the hardware configuration of the management server 60A and description of the corresponding configuration will be omitted. The management server 60A is connected to, for example, the access points AP1 and AP2 to allow communication with each other. The number of access points is shown as two in order to simplify the following description, but a communication area of each of three or more access points can be set in the same manner.

As shown in FIG. 6, the setting computer 60 or the management server 60A acquires, from each of the plurality of access points AP1 and AP2, area parameter information in which its own communication area is defined, and holds the area parameter information in the memory 63 or the storage 64. The setting computer 60 or the management server 60A holds position information of each of the plurality of access points AP1 and AP2 in the memory 63 or the storage 64, generates the area designation field GRP2 in FIG. 6 using the area parameter information and the position information of each of the plurality of access points AP1 and AP2, and displays the area designation field GRP2 on the display 65.

In a first setting example, the setting computer 60 or the management server 60A can collectively set the communication areas of the plurality of access points AP1 and AP2 on one screen (that is, the area designation field GRP2) by a user operation on the area designation field GRP2 in FIG. 6. For example, when an overlapping area AR0 is designated as a connection permitted area by a user operation, the setting computer 60 or the management server 60A collectively changes the overlapping area AR0 to the connection permitted area in the area parameter information of each of the plurality of access points AP1 and AP2. Similarly, when the overlapping area AR0 is designated as a connection prohibited area by a user operation, the setting computer 60 or the management server 60A collectively changes the overlapping area AR0 to the connection prohibited area in the area parameter information of each of the plurality of access points AP1 and AP2. In areas other than the overlapping area AR0 in the communication areas AR1 and AR2, a connection permitted area or a connection prohibited area may be individually set by a user operation as described with reference to FIG. 3 or 5. Accordingly, the user can intuitively and visually determine the connection permitted area or the connection prohibited area in the area in which each of the plurality of access points AP1 and AP2 is used.

In a second setting example, the setting computer 60 or the management server 60A can individually set the communication areas of the plurality of access points AP1 and AP2 on one screen (that is, the area designation field GRP2) by a user operation on the area designation field GRP2 in FIG. 6. For example, the setting computer 60 or the management server 60A displays, in the area designation field GRP2, options (for example, pull-down options) for designating any one of a connection permitted area or a connection prohibited area for each of the overlapping area AR0 in the communication area AR1 and the overlapping area AR0 in the communication area AR2. The setting computer 60 or the management server 60A receives a designation result of the user operation, individually changes the overlapping area AR0 in the communication area AR1 to a connection permitted area or a connection prohibited area, and individually changes the overlapping area AR0 in the communication area AR2 to a connection permitted area or a connection prohibited area in the area parameter information of each of the access points AP1 and AP2. In areas other than the overlapping area AR0 in the communication areas AR1 and AR2, a connection permitted area or a connection prohibited area may be individually set by a user operation as described with reference to FIG. 3 or 5. Accordingly, for example, in access points respectively located in a place with a large number of people and a place with a small number of people, the user can set an access point with a large number of people (that is, an access point with a large number of wireless connection terminals such as a connected millimeter wave receiver) as a connection prohibited area in the overlapping area AR0, and similarly, can set an access point with a small number of people (that is, an access point with a small number of wireless connection terminals such as a connected millimeter wave receiver) as a connection permitted area in the overlapping area AR0. Therefore, it is possible to prevent occurrence of a bias in the number of wireless connection terminals connected to an access point, and the numbers of wireless connection terminals to the access points AP1 and AP2 are balanced, thereby improving efficiency of wireless communication.

As described above, the millimeter wave transmitter 10 according to the first embodiment acquires, by the processor 11, distance information indicating a distance to a communication target (for example, the millimeter wave receivers 30 to 50), acquires, by the processor 11, setting information (for example, area parameter information) including a communication distance, and communicates with the communication target via the communication IF circuit 16 and the wireless antenna 17. After connection is established with the communication target, the millimeter wave transmitter 10 acquires distance information from the millimeter wave transmitter 10 to at least the communication target, and cuts the connection with the communication target when the distance information does not satisfy the communication distance included in the setting information.

Accordingly, the millimeter wave transmitter 10 can comfortably perform wireless communication with a receiver (for example, a millimeter wave receiver located in a connection permitted area) satisfying setting information set by a user operation, and on the other hand, can prevent wireless connection with a receiver (for example, a millimeter wave receiver located in a connection prohibited area) satisfying setting information set by a user operation. Therefore, communication performance expected by the installation operator of the wireless communication system 1 can be provided comfortably to a user.

The millimeter wave transmitter 10 acquires, by the processor 11, direction information indicating an orientation toward the communication target. The setting information further includes a communication direction. After the connection is established with the communication target, the millimeter wave transmitter 10 acquires the direction information, and cuts the connection with the communication target when the direction information does not match the communication direction included in the setting information. Accordingly, the millimeter wave transmitter 10 can perform millimeter wave communication with a millimeter wave receiver in a connection permitted area specified based on two pieces of information (distance, azimuth) from the millimeter wave transmitter 10, and can avoid execution of millimeter wave communication with a millimeter wave receiver in a connection prohibited area specified based on the two pieces of information.

The millimeter wave transmitter 10 communicates with the communication target via transmission and reception of a wireless signal based on beam forming using a frequency in a millimeter wave band. Accordingly, the millimeter wave transmitter 10 can perform millimeter wave communication with a millimeter wave receiver in a connection permitted area according to an intention of a user in a pinpoint manner by beam forming using a distance and an azimuth, instead of a form of wireless communication like Wi-fi (registered trademark) in which wireless connection can be uniformly performed over a uniform range (for example, a circular range) from a transmitter.

When connection is established with a first communication target (for example, the millimeter wave receiver 40) located in a communication direction with respect to the millimeter wave transmitter 10 and located at a position separated by a first distance (for example, a distance from the millimeter wave transmitter 10 to the millimeter wave receiver 40 in FIG. 1) not satisfying a communication distance, the millimeter wave transmitter 10 cuts the connection with the first communication target. On the other hand, when connection is established with a second communication target (for example, the millimeter wave receiver 50) located in the same communication direction with respect to the millimeter wave transmitter 10 and located at a position separated by a second distance (for example, a distance from the millimeter wave transmitter 10 to the millimeter wave receiver 50 in FIG. 1) larger than the above-described first distance while satisfying the communication distance, the millimeter wave transmitter 10 communicates with the second communication target. Accordingly, by beam forming using two parameters (distance, azimuth), the millimeter wave transmitter 10 can perform millimeter wave communication with the millimeter wave receiver 50 located far from the millimeter wave transmitter 10 without performing millimeter wave communication with the millimeter wave receiver 40 located near the millimeter wave transmitter 10. Therefore, wireless connection like Wi-fi (registered trademark), which is established with a receiver located within a uniform distance range at any time, does not occur, wireless connection with an unintended receiver can be avoided, and wireless communication suitable for an intention of a system designer can be realized.

The millimeter wave transmitter 10 calculates and acquires the distance information based on a round trip time of a wireless signal transmitted and received by the communication IF circuit 16 when the connection is established with the communication target. Accordingly, the millimeter wave transmitter 10 can accurately calculate the distance to the communication target.

Although various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in various embodiments described above may be combined optionally in a range without deviating from the spirit of the invention.

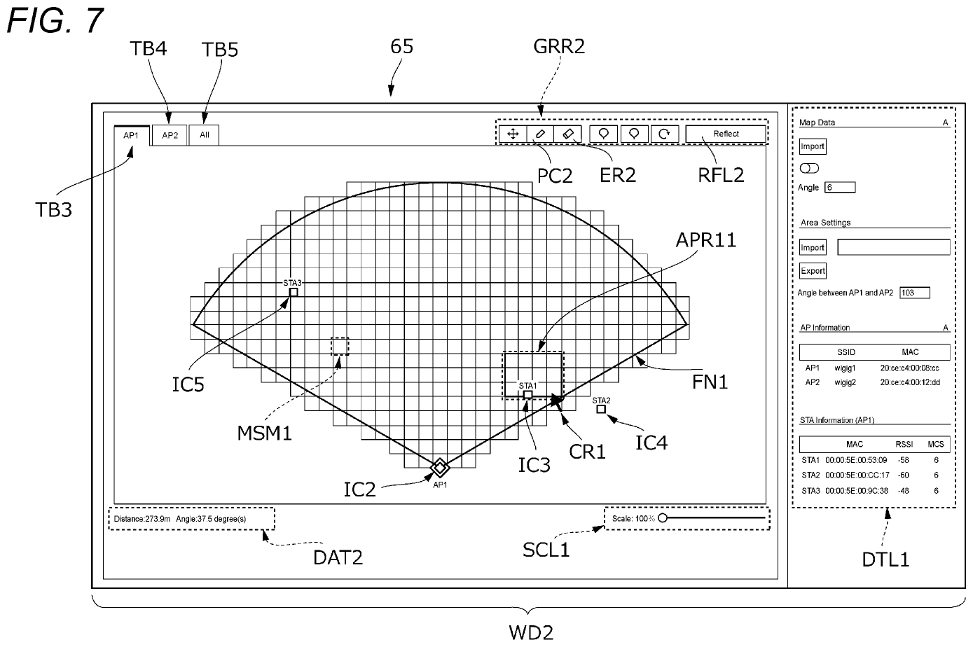

The first embodiment described above shows that the processor 61 of the setting computer 60 displays the communication area setting screen WD1 in FIG. 3 as an example of the communication area setting screen, but a communication area setting screen shown in FIG. 7, 8, or 9 may be displayed. Hereinafter, variation examples of the communication area setting screen will be described with reference to FIGS. 7, 8, and 9.

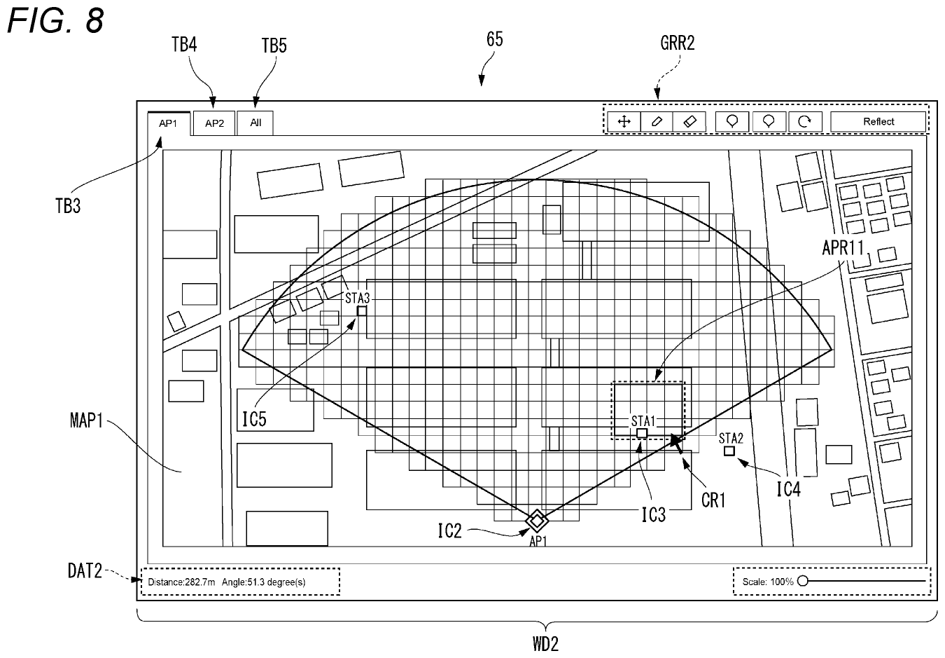

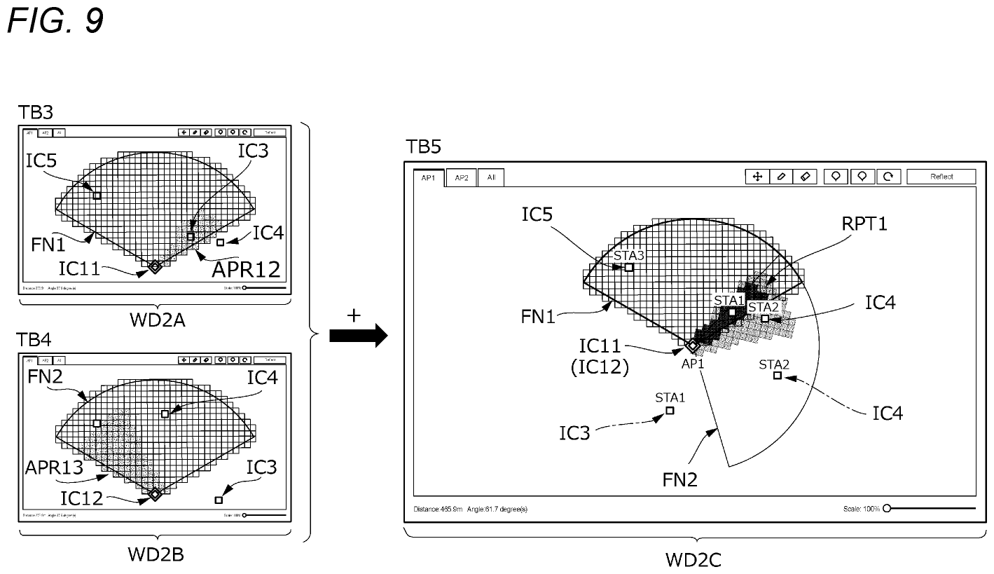

Each of FIGS. 7 and 8 is a diagram showing another example of the communication area setting screen displayed on the setting computer 60. FIG. 9 is a diagram showing a switching example of the communication area setting screen displayed on the setting computer 60. In description of FIGS. 8 and 9, elements overlapping with elements in FIG. 7 are denoted by the same reference numerals, description thereof will be simplified or omitted, and different contents will be described. In description of FIGS. 7 to 9, description of FIG. 3 is similarly applied to elements overlapping with the elements in FIG. 3.

The communication area setting screen WD2 is displayed on the display 65 of the setting computer 60 by, for example, a user operation using a cursor CR1. Similarly to the communication area setting screen WD1, in the communication area setting screen WD2, a position allowed as a position of a millimeter wave receiver to which the millimeter wave transmitter 10 performs millimeter wave communication is designated according to two parameters of a distance and an azimuth. Specifically, the communication area setting screen WD2 includes a circular sector communication area map image FN1 in which a position to be a communication area of the millimeter wave transmitter 10 is designated, a designation tool display field GRR2 which supports designation by a user operation, and a communication area map detail field DTL1.

First, the same circular sector communication area map image shown in the communication area setting screen WD1 in FIG. 3 and corresponding to the communication area map image FN1 is implemented by a radial grid in which a plurality of quadrangular blocks are radially arranged so as to coincide with an area surrounded by a frame line of a circular sector formed by part of a circle with the icon IC1 indicating the position of the millimeter wave transmitter 10 as a center of the circle. Accordingly, the user can easily designate the area parameter information of the connection permitted area or the connection prohibited area by designating any quadrangular block radially extending from the icon IC1 indicating the position of the millimeter wave transmitter 10.

On the other hand, the communication area map image FN1 in FIG. 7 is implemented by a lattice-shaped grid in which a plurality of quadrangular blocks MSM1 are arranged in a lattice-shaped pattern so as to surround an area having a size surrounded by a frame line of a circular sector formed by part of a circle with an icon IC2 indicating a position of the millimeter wave transmitter 10 as a center of the circle. Accordingly, the user can more intuitively designate area parameter information of a connection permitted area or a connection prohibited area by designating any quadrangular block extending in a lattice-shaped pattern from the icon IC2 indicating the position of the millimeter wave transmitter 10. Particularly, in a case of the radial grid in FIG. 3, a size of the quadrangular block is not uniform, and for example, is larger as a distance from the icon IC1 increases, which may cause a problem when the user intuitively performs designation. However, according to the lattice-shaped grid in FIG. 7, a size of the quadrangular block MSM1 is uniform regardless of a distance from the icon IC2, and thus the user can intuitively perform designation.

In FIG. 7, a communication area map image is displayed in a displayable manner for each millimeter wave transmitter 10 (for example, an access point) for which area parameter information is to be set, and one communication area map image corresponding to a tab specified by designation for tabs TB3, TB4, and TB5 is displayed. In FIG. 7, the communication area map image FN1 corresponding to the tab TB3 is displayed.

The communication area map image FN1 receives the above-described designation of the connection permitted area and the connection prohibited area by the user operation in a circular sector communication area with the position of the millimeter wave transmitter 10 indicated by the icon IC2 as a center (in other words, an origin of a two-dimensional coordinate system). Each of the connection permitted area and the connection prohibited area is designated in a form of two-dimensional coordinates of (distance, azimuth). For example, a position of an icon IC3 indicating a millimeter wave receiver (denoted as “STA1”) located in a user designation area APR11 currently designated by the cursor CR1 is indicated as (273.9 m, 37.5 degrees) specified by a current value data display field DAT2. An icon IC4 indicating another millimeter wave receiver (denoted as “STA2”) and an icon IC5 indicating another millimeter wave receiver (denoted as “STA3”) are disposed by a user operation, but these millimeter wave receivers are not disposed in the user designation area APR11.

The “distance” indicates a distance at which the millimeter wave transmitter 10 can perform millimeter wave communication. Similarly, the “azimuth” indicates a range (a direction) in which the millimeter wave transmitter 10 can form directivity by beam forming when viewed from its own position. The communication area map image FN1 in FIG. 7 is displayed at a display magnification of 100%, but the display magnification may be changed as appropriate by a user operation on a scaler SCL1 using the cursor CR1.

Similarly to the drawing icon PC1 in FIG. 3, a drawing icon PC2 in the designation tool display field GRR2 is designated by a user operation when an area (for example, the user designation area APR11) consisting of any one or more quadrangular blocks is drawn and selected as a connection permitted area with respect to the communication area map image FN1. Similarly to the eraser icon ER1 in FIG. 3, an eraser icon ER2 in the designation tool display field GRR2 is designated when a connection permitted area candidate drawn and selected by a user operation in the communication area map image FN1 is deleted by a user operation. Similarly to the reflection icon RFL1 in FIG. 3, a reflection icon RFL2 in the designation tool display field GRR2 is designated by a user operation when an instruction is made to set and reflect, as the connection permitted area, an area (for example, the user designation area APR11) currently selected as a connection permitted area candidate.

The processor 61 of the setting computer 60 may display, by a user operation, the communication area setting screen WD2 in which map data MAP1 such as a map including an arrangement point of the millimeter wave transmitter 10 specified by the icon IC2 is displayed on a background of the communication area map image FN1 (see FIG. 8). Specifically, based on a user operation, the processor 61 displays, on the display 65, the communication area setting screen WD2 in which the communication area map image FN1 is superimposed on the map data MAP1. The map data MAP1 may be an image with poor visibility (for example, a dark image). Therefore, when the communication area map image FN1 is superimposed on the map data MAP1, the processor 61 displays the communication area map image FN1 on the communication area setting screen WD2 by brightening an area corresponding to the communication area map image FN1 (in other words, by performing color inversion or the like so as to have a contrast compared with the map data MAP1). Accordingly, the user can easily designate a connection permitted area or a connection prohibited area in a state where the communication area map image FN1 has good visibility while viewing the map data MAP1 in which the map of the arrangement point of the millimeter wave transmitter 10 or a periphery thereof can be determined, and operability of the user is improved. Particularly, the map data MAP1 having good visibility is displayed on the background of the communication area map image FN1, so that the user can efficiently designate area parameter information while visually grasping an actual location of a quadrangular block MSM1 designated by himself/herself.

The processor 61 may switch on and off the display of the map data MAP1 shown in FIG. 8 and display the communication area setting screen WD2 by a user operation. Accordingly, for example, when the user already knows the arrangement point of the icon IC2 of the millimeter wave transmitter 10 or the periphery thereof, the user can designate the area parameter information in a state where the map data MAP1 is hidden.

When any one of the tab TB3, TB4, or TB5 is designated by a user operation, the processor 61 of the setting computer 60 may switch and display a communication area setting screen corresponding to the designation (see FIG. 9). For example, in a communication area setting screen WD2A corresponding to the tab TB3 in FIG. 9, a user designation area APR12 corresponding to a first millimeter wave transmitter specified by an icon IC11 is designated in the communication area map image FN1. A millimeter wave receiver (denoted as “STA1”) specified by the icon IC3 is disposed in a user designation area APR12, but millimeter wave receivers (denoted as “STA2” and “STA3”) specified respectively by the icons IC4 and IC5 are not disposed in the user designation area APR12.

In a communication area setting screen WD2B corresponding to the tab TB4 in FIG. 9, a user designation area APR13 corresponding to a second millimeter wave transmitter specified by an icon IC12 is designated in a communication area map image FN2. Millimeter wave receivers (denoted as “STA1” and “STA2”) specified by the icons IC3 and IC4, respectively, are not disposed in the user designation area APR13.

The processor 61 displays, on a communication area setting screen WD2C corresponding to the tab TB5, a communication area map image obtained by adding the communication area map image FN1 corresponding to the tab TB3 and the user designation area APR12 with the communication area map image FN2 corresponding to the tab TB4 and the user designation area APR13. At this time, the processor 61 displays any one communication area map image (for example, the communication area map image FN1) designated by a user operation to be valid (active), and displays the other one or more communication area map images (for example, the communication area map image FN2) to be invalid (inactive). When an area RPT1 overlapping with the user designation areas APR12 and APR13 is present, the processor 61 may display the area RPT1 more distinguishably (for example, darker) than the user designation areas APR12 and APR13. Accordingly, the user can grasp a connection permitted area or a connection prohibited area for each of a plurality of millimeter wave transmitters 10 at a time, and can efficiently designate area parameter information.

As described above, the setting computer 60 further includes the processor 61 that displays, on the display 65, a setting screen (for example, the communication area setting screen WD2) for designating setting information (for example, the above-described area parameter information) by a user operation. The processor 61 acquires the setting information and transmits the acquired setting information to a communication device (for example, the millimeter wave transmitter 10) based on a user operation on the setting screen displayed on the display 65. Accordingly, the user can easily and intuitively designate the setting information while viewing the communication area setting screen WD2 displayed on the display 65.

The processor 61 displays, on the display 65, a setting screen (for example, the communication area setting screen WD1 in FIG. 3) including a circular sector communication area map image in which a plurality of quadrangular blocks are arranged radially from a position of a communication device (for example, the millimeter wave transmitter 10). The processor 61 acquires setting information based on designation of one or more quadrangular blocks constituting the communication area map image by a user operation. Accordingly, the user can easily designate area parameter information of a connection permitted area or a connection prohibited area by designating any quadrangular block radially extending from the icon IC1 indicating the position of the millimeter wave transmitter 10.

The processor 61 displays, on the display 65, a setting screen (for example, the communication area setting screen WD2 in FIG. 7) including a circular sector communication area map image FN1 in which a plurality of quadrangular blocks are arranged in a lattice-shaped pattern from a position of a communication device (for example, the millimeter wave transmitter 10). The processor 61 acquires setting information based on designation of one or more quadrangular blocks MSM1 constituting the communication area map image FN1 by a user operation. Accordingly, the user can more intuitively designate area parameter information of a connection permitted area or a connection prohibited area by designating any quadrangular block extending in a lattice-shaped pattern from the icon IC2 indicating the position of the millimeter wave transmitter 10.

The processor 61 displays, on the display 65, the map data MAP1 selected by a user operation in a manner of being superimposed on a setting screen (for example, the communication area setting screen WD2). Accordingly, the user can easily designate a connection permitted area or a connection prohibited area in a state where the communication area map image FN1 has good visibility while viewing the map data MAP1 in which the map of the arrangement point of the millimeter wave transmitter 10 or the periphery thereof can be determined, and the operability of the user is improved.

A plurality of communication devices (for example, the millimeter wave transmitters 10) may be provided. The processor 61 displays, on the display 65, a composite setting screen (for example, the communication area setting screen WD2C) in which a setting screen (for example, the communication area setting screen WD2A, WD2B) corresponding to each of the plurality of communication devices (for example, the millimeter wave transmitters 10) is disposed. Accordingly, the user can grasp a connection permitted area or a connection prohibited area for each of a plurality of millimeter wave transmitters 10 at a time, and can efficiently designate area parameter information.

The present application is based on Japanese Patent Application No. 2019-239223 filed on Dec. 27, 2019 and International Patent Application No. PCT/JP2020/041255 filed on Nov. 4, 2020, the contents of which are incorporated herein by reference.

The present disclosure is useful as a communication device, a communication method, and a communication system that comfortably performs wireless communication with a receiver located in a connection permitted area set by a user operation and prevents wireless connection with a receiver located in a connection prohibited area set by a user operation.

What is claimed is:

1. A communication device comprising:
a distance information acquisition unit configured to acquire distance information indicating a distance to a communication target;
a setting information acquisition unit configured to acquire setting information including a communication distance; and
a communication unit configured to communicate with the communication target,
wherein the distance information acquisition unit acquires the distance information after the communication unit establishes connection with the communication target, and
wherein the communication unit cuts the connection with the communication target in a case in which the distance information does not satisfy the communication distance included in the setting information.

2. The communication device according to claim 1, further comprising:
a direction information acquisition unit configured to acquire direction information indicating an orientation toward the communication target,
wherein the setting information further includes a communication direction,
wherein the direction information acquisition unit acquires the direction information after the communication unit establishes the connection with the communication target, and
wherein the communication unit cuts the connection with the communication target in a case in which the direction information does not match the communication direction included in the setting information.

3. The communication device according to claim 1,
wherein the communication unit is configured to communicate with the communication target via transmission and reception of a wireless signal based on beam forming using a frequency in a millimeter wave band.

4. The communication device according to claim 2,
wherein in a case in which connection is established with a first communication target located in the communication direction with respect to the communication device and located at a position separated by a first distance not satisfying the communication distance, the communication unit is configured to cut the connection with the first communication target, and
wherein in a case in which connection is established with a second communication target located in the same communication direction with respect to the communication device and located at a position separated by a second distance that is larger than the first distance and satisfies the communication distance, the communication unit is configured to communicate with the second communication target.

5. The communication device according to claim 1,
wherein the distance information acquisition unit is configured to calculate and acquire the distance information based on a round trip time of a wireless signal transmitted and received by the communication unit in response to establishment of the connection with the communication target.

6. A communication method comprising:
acquiring distance information indicating a distance to a communication target after connection is established with the communication target;
acquiring setting information including a communication distance;
cutting the connection with the communication target in a case in which the distance information does not satisfy the communication distance included in the setting information; and
communicating with the communication target in a case in which the distance information satisfies the communication distance included in the setting information.

7. A communication system comprising:
a communication device capable of communicating with a communication target; and
a setting terminal connected to the communication device to allow communication therebetween,
wherein the communication device comprises:
a distance information acquisition unit configured to acquire distance information indicating a distance to a communication target;
a setting information acquisition unit configured to acquire, from the setting terminal, setting information including a communication distance and set by the setting terminal; and
a communication unit configured to communicate with the communication target,
wherein the distance information acquisition unit acquires the distance information after the communication unit establishes connection with the communication target, and
wherein the communication unit cuts the connection with the communication target in a case in which the distance information does not satisfy the communication distance included in the setting information.

8. The communication system according to claim 7,
wherein the setting terminal comprises:
a processor configured to display a setting screen on a display, the setting screen allowing designation of the setting information by a user operation, and
wherein the processor is configured to acquire the setting information and transmit the acquired setting information to the communication device based on the user operation on the setting screen displayed on the display.

9. The communication system according to claim 8,
wherein the processor is configured to:
display the setting screen on the display, the setting display including a circular sector communication area map image in which a plurality of quadrangular blocks are arranged radially from a position of the communication device; and
acquire the setting information based on designation, by the user operation, of one or more quadrangular blocks of the plurality of quadrangular blocks constituting the communication area map image.

10. The communication system according to claim 8,
wherein the processor is configured to:
display the setting screen on the display, the setting screen including a circular sector communication area map image in which a plurality of quadrangular blocks are arranged in a lattice-shaped pattern from a position of the communication device; and
acquire the setting information based on designation, by the user operation, of one or more quadrangular blocks of the plurality of quadrangular blocks constituting the communication area map image.

11. The communication system according to claim 8,
wherein the processor is configured to:
display map data selected by the user operation on the display such that the map data is superimposed on the setting screen.

12. The communication system according to claim 8,
wherein the communication system comprises a plurality of communication devices, and
wherein the processor is configured to display a composite setting screen on the display, the composite setting screen including setting screens corresponding to the respective communication devices.
